(19) United States
(12) Patent Application Publication
(10) Pub. No.: US 2013/0033590 A1
(43) Pub. Date: Feb. 7, 2013

(54) Real-Time Skin Color Visualization and Classification Tool

(71) Applicants: Sumera Yacoob, Mississauga (CA); Imran Somji, Thornhill (CA)

(72) Inventors: Sumera Yacoob, Mississauga (CA); Imran Somji, Thornhill (CA)

(21) Appl. No.: 13/196,974

(22) Filed: Aug. 3, 2011

(51) Int. Cl. H04N 7/18

(52) U.S. Cl. 348/77; 348/E07.085

(57) ABSTRACT

The present invention makes use of a camera feed input to calculate in real time, and simultaneously display: the skin color of a subject, the most comparable colored item from a predetermined array of colored items, and the camera feed output. The simultaneous and real time feedback of the skin color and the selected colored item enable the user to adjust the camera until the closest match is identified. The user can at any point choose to view further details about a given item including purchasing a corresponding product online.

### BACKGROUND OF THE INVENTION

The primary use of the invention is for use in the cosmetics industry to match subjects with the best products suitable for their skin color.

Cosmetic products such as foundation are required to match a subject's skin color as closely as possible. Given that there are thousands of possible products available that are just a few shades apart from each other, the precision required to match skin color is of utmost importance.

Currently the selection of the best product is either through the recommendation of an expert who may not be available, or by trial and error. These solutions both resort to guessing and can lead to incorrect selections which results in non-optimal appearance of the consumer and can be costly.

Prior art has also proposed an inadequate solution U.S. Pat No. 20070071314A1, which fails to provide visual feedback until the final result is returned from a server. Unknown to the user, the quality of the image inputted (and subsequently the calculated result), is affected by several environmental factors including: shadows, bright spots (ex. glare), external intrusions (ex. hair and moles), defects or variations in the skin color, inadequate lighting, blur created as the user clicks to create the image, etc.

As such there is a need for an invention which removes the aforementioned guesswork, human expertise, or inadequacies.

### SUMMARY OF THE INVENTION

The invention makes use of a camera feed (ex. one often found on smart devices such as mobile phones, tablets or any other device) to provide a real-time view of the calculated skin color and the best matching cosmetics product displayed alongside the camera feed. This allows the user to visually compare if the skin color displayed and the corresponding product are an accurate representation of the true image displayed in the camera feed instantaneously. The user can continuously adjust the position of the camera to escape the negative environmental factors all the while judging by the feedback if the skin color match is accurate. Once a satisfactory skin color is provided, the user can select to view the details of the corresponding product and be given the option to purchase it online.

In one embodiment of the invention, the skin color s is calculated by averaging the color values of all n pixels within a predefined window of the current camera feed image:

$$s = ( ( {\sum }_{i = 0}^{n} {r}_{i} ) / n , ( {\sum }_{i = 0}^{n} {g}_{i} ) / n , ( {\sum }_{i = 0}^{n} {b}_{i} ) / n )$$

In one embodiment of the invention, the selected product p has the minimum Euclidean distance to the skin color s of all n products:

p=minᵢ₌₀ⁿ{\sqrt{(rₛ−rₚᵢ)²+(gₛ−gₚᵢ)²+(bₛ−bₚᵢ)²}}

### FIGURES

The patent or application file contains at least one drawing executed in color. Copies of this patent or patent application publication with color drawing(s) will be provided by the Office upon request and payment of the necessary fee.

FIG. 1a shows the live camera feed from an input device. The cross-hairs define the size and region of the target window. This variable-sized window can be identified by cross-hairs, a box, by any other geometric shape or means, or can be hidden from the user all-together.

FIG. 1b shows the calculated skin color within the target window of the camera feed.

FIG. 1c is a view of the palette of possible products. There can be many embodiments. This one displays the the range of all possible product colors with the one that is nearest to the current skin color being highlighted. Other embodiments could show the product names, model numbers, labels, images or any other meaningful identifiers.

FIG. 1d shows the closest product to the calculated skin color and can also display the product name, model number, label, image or any other meaningful identifier. Also indicated here is an capture button which allows the user to capture and view the currently displayed product's details or purchase it online. This button may appear anywhere in the interface or not at all and can be triggered by a hardware key or button.

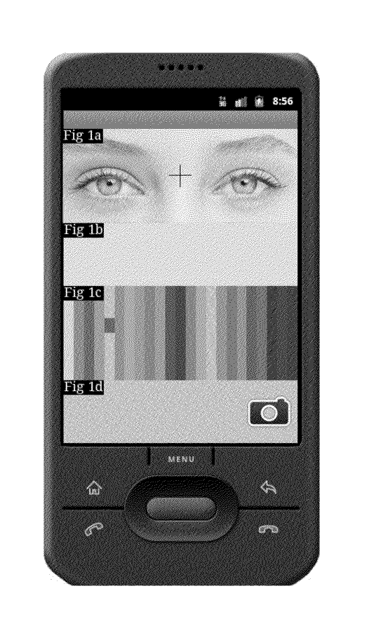

We claim:

1. A device with a camera input which, when aimed at human skin, displays simultaneously and updates in real-time: the camera feed output; a skin color calculated from a window within the camera feed; and the most comparable colored item from a predetermined array of colored items.

2. A device as in claim 1, wherein the predetermined array of items is also displayed with the most comparable items visually identified and ranked.

3. A device as in claim 1, wherein other cosmetic products that coordinate with the given skin color are suggested.

4. A device as in claim 1, which notifies the user of inadequate or incorrect lighting.

5. A device as in claim 1, which identifies and outlines defect areas of the displayed skin and filters them out of the skin color calculation. Defect areas include: shadows, bright spots (ex. glare), external intrusions (ex. hair and moles), defects or variations in the skin color, etc.

6. A device as in claim 1, where the user can view a description of any of the items, including the identified one, and purchase the item online.
